(19) United States
(12) Patent Application Publication
(10) Pub. No.: US 2008/0120192 A1
(43) Pub. Date: May 22, 2008

(54) COMMISSION STATEMENT GENERATOR

(75) Inventors: Chris Lilly, Woodbury, MN (US); Jerry C. Drumm, Mount Holly, NC (US); Christopher Dix, Matthews, NC (US)

Correspondence Address: GREENBERG TRAURIG, LLP, 1200 SEVENTEENTH STREET, SUITE 2400, DENVER, CO, 80202, US

(73) Assignee: Best Vendors Management, Inc., Minneapolis, MN (US)

(21) Appl. No.: 11/552,456

(22) Filed: Oct. 24, 2006

(51) Int. Cl. G06Q 20/00

(52) U.S. Cl. 705/22; 705/30

(57) ABSTRACT

Systems and methods are described for securely generating a validated commission statement so that the recipient can be confident that the contents of the validated commission statement meet the recipients dynamically generated validation requirements. The systems and methods collect data from the vending machine operator's sources and then checks the vending data against validation data dynamically generated by the intended recipient of the commission statement. Discrepancies within the vending data are identified and the operator is required to resolve the discrepancies before the commission statement may be validated and transmitted to the intended recipient. In an embodiment, the systems and methods generate an encrypted draft commission statement that can only be accessed through the system allowing the operator to edit the draft statement over time until it meets the validation requirements

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Many large retail chains now lease out the rights to place vending machines in individual stores for a commission on sales of the vending machines. As the large chains prefer not to negotiate individual contracts for each store, typically the lessee is a vending management company that then negotiates the individual store contracts with local vending machine operators; manages the performance of the operators; and provides the appropriate commission to the retail chain.

In order to verify the reliability of the figures provided by the local operators and thus provide to the retail chain that sales are not being under-reported, one task is to audit the data provided by each local operator every reporting period, which is usually monthly. This is a huge task, not only because of the shear number of vending machine sales at the individual stores, but also because of the common industry practice to move vending machines into, and out of, service and between locations often and continuously. This practice requires that the data from each machine at each location be tracked and verified individually.

Typically, the local operators provide a commission statement for a given period directly to the vending management company. The vending management company then checks the commission statement for errors, such as machines that were listed as being at a location in the last statement but which do not appear in the current statement. The local operator is then alerted to the errors and asked to correct the statement, which can take significant time and cause a significant delay.

Validating the commission statement for each operator represents a major portion of the work of the vending management company. In addition, as the vending management company typically does not get paid until the commissions are paid, any delays in providing the verified data and certifying the accuracy of the commissions to the retail chain is a delay in the payment of the vending management company.

### SUMMARY

Against this backdrop systems and methods have been developed for securely generating a validated commission statement so that the recipient can be confident that the contents of the validated commission statement meet the recipients dynamically generated validation requirements. The systems and methods collect data from the vending machine operator's sources and then checks the vending data against validation data dynamically generated by the intended recipient of the commission statement. Discrepancies within the vending data are identified and the operator is required to resolve the discrepancies before the commission statement may be validated and transmitted to the intended recipient. In an embodiment, the systems and methods generate an encrypted draft commission statement that can only be accessed through the system allowing the operator to edit the draft statement over time until it meets the validation requirements.

In one aspect, the invention may be considered a method for generating a validated vending machine commission statement for submission to a recipient. The method includes receiving a request from an operator to generate a validated commission statement for a period from vending sales data for the period. From the vending sales data, a machine list is generated containing vending site data, the vending site data identifying at least one vending site and vending machines associated with each at least one vending site. In addition, a validation schedule is accessed for the period, the validation schedule containing vending site validation data derived from a previously submitted validated vending machine commission statement, in which the vending site validation data includes a list of one or more expected vending sites and, for each expected vending site, an expected vending machine. The method further includes generating a draft commission statement containing the vending site data from the machine list and expected vending sites and expected vending machines that are not also included in the vending site data. Site sales data is accessed for each vending machine and expected vending machine and the validated vending machine commission statement is generated. The validated vending machine commission statement contains the vending site data from the machine list and expected vending sites and expected vending machines, site sales data for each vending machine and expected vending machine and a validation certificate.

In another aspect, the invention may be considered a system and method for generating a vending machine commission statement. The method includes retrieving, from one or more sources, vending data for a period, wherein the vending data is related to machines located at different sites, wherein each machine is associated with at least one site. The method includes verifying that each site listed in the vending data is listed in a validation schedule and verifying that at least one machine associated with each site in the vending data is listed in the validation schedule as associated with the same site. Then a validated vending machine commission statement containing the vending data is generated.

In yet another aspect, the invention may be considered a system for generating a validated commission statement from sales data. The system includes a computer-executable software application that when executed can retrieve sales data from at least one data source, the sales data including vending data for a period, the vending data related to machines located at different sites, wherein each machine is associated with at least one site. The application is further adapted to verify that each site listed in the vending data is listed in a validation schedule and to verify that at least one machine associated with each site in the vending data is listed in the validation schedule as associated with the same site. In addition, the application further adapted to generate validated commission statement containing the vending data. The system may also include a client computing device adapted to execute the application and upon which the application is stored or otherwise accessed.

These and various other features as well as advantages will be apparent from a reading of the following detailed description and a review of the associated drawings. Additional features are set forth in the description which follows, and in part will be apparent from the description, or may be learned by practice of the described embodiments. The benefits and features will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of embodiments systems and methods described below and are not meant to limit the scope of the invention in any manner, which scope shall be based on the claims appended hereto.

FIG. 1 illustrates the elements in a simplified vending machine environment.

FIG. 2 illustrates a high-level embodiment of a method for generating a commission statement.

FIG. 3 illustrates an embodiment of a client-server system for generating a commission statement.

FIG. 4 is an embodiment a decrypted validation schedule as displayed to a user by the application.

FIG. 5 illustrates an embodiment of a graphical user interface displayed by the application.

FIG. 6 illustrates another embodiment, in greater detail, of a method for validating a commission statement.

FIG. 7 illustrates an embodiment of a user interface displayed to a user as part of the period selection operation.

FIG. 8 illustrates an embodiment of a user interface displayed to a user as part of the validation schedule retrieval operation.

FIG. 9 illustrates an embodiment of a user interface displayed to a user upon verifying that the vending machines in the machine list match the data in the validation schedule.

FIG. 10 illustrates an embodiment of a user interface displayed to a user for selecting and entering exception codes as part of the validation of the machine list.

FIG. 11 illustrates an embodiment of a user interface displayed to a user for manually entering sales data.

FIG. 12 illustrates an embodiment of a user interface displayed to a user when retrieving additional sales data from a local data source.

FIG. 13 illustrates an embodiment of a user interface displayed to a user when retrieving additional sales data from a remote data source or system.

FIG. 14 illustrates an embodiment of a user interface displayed to a user as part of the validation and verification of sales data.

### DETAILED DESCRIPTION

The specification discloses systems and methods for the efficient generation and reporting of commission statements. The systems and methods are described in the context of reporting a commission statement for a group of vending machines at various sites. However, the systems and methods described herein are broadly applicable to other applications including commission statements related to video games, automated teller machines, and other remote services in which money transactions are involved.

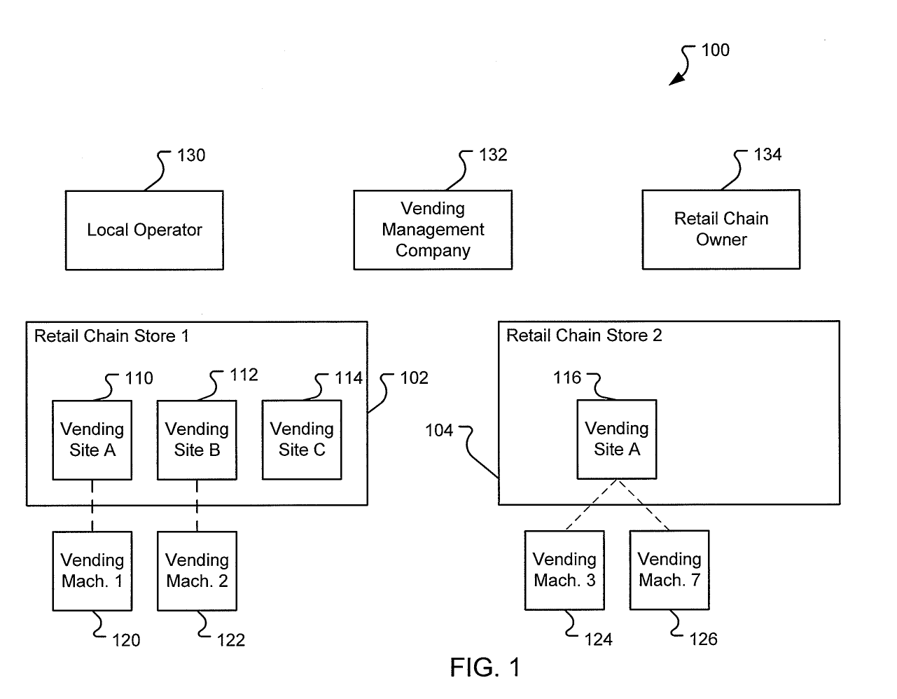

FIG. 1 illustrates the elements in a simplified vending machine environment to assist in the description of the systems and methods disclosed herein. One skilled in the art will recognize that the environment 100 is but one example of an environment to which the systems and methods described below may be adapted. For example, the system could also be adapted to providing vending machines in other environments including corporate campuses, airports, schools and universities. Essentially, the systems and methods described herein could be used to manage vending machines located in any high-traffic area regardless of the nature of the machines or the facilities in which they are located.

In the embodiment shown, a retail chain owner 134 operates or controls the operation of some number of retail chain stores 102, 104. In the simple embodiment shown, two stores 102, 104 are illustrated although the reader will recognize that more or fewer stores may be managed using the systems and methods described herein. In the embodiment, the retail chain owner 134 uses a vending management company 132 to manage one or more local vending machine operators 130 that are responsible for the individual vending machines 120, 122, 124, 126.

Each retail chain store 102, 104 includes at least one, and usually more, vending sites 110, 112, 114, 116. In the embodiment shown, the first retail chain store 102 is illustrated with three vending sites 110, 112, 114 and the second retail chain store 104 is illustrated with two vending sites 116. A vending site 110, 112, 114, 116 may be a specified location within a store 102, 104 that is set aside specifically for vending machines, such as the vending machines 120, 122, 124, 126 shown. Alternatively, a vending site may more broadly correspond to a particular store 102, 104, address, or other location identifier that could contain one or more vending machines (as illustrated in FIG. 1 by vending site 116 having two machines 124, 126), in which case there may be no difference between a store location 102, 104 and a vending site.

For embodiments in which vending sites 110, 112, 114, 116 are narrowly defined as specific individual machine locations, the vending sites 110, 112, 114, 116 at each store may be designated by the retail chain owner 134. For example, a retail chain owner 134 may design and build the stores 102, 104 with specific locations set aside for vending sites. Alternatively, the retail chain owner 134 may allow each store manager to identify the location and number of vending sites in each particular store. Regardless, the number of vending sites 110, 112, 114, 116 at each store 102, 104 may be known. In an embodiment, the retail chain owner 134 may provide each vending site 110, 112, 114, 116 with a site identifier in order to track the income from vending machines located at each particular site.

The vending machines 120, 122, 124, 126 may be any type of machine, now known or later developed, that takes a payment from a customer. Often, but not necessarily, such a payment is taken in return from some product (e.g., drink, food, parking, cash dispensation, telephone card, etc.) or service (e.g., change counting). Common examples of vending machines include machines the dispense drinks, food or small toiletries.

In an embodiment, the vending machines 120, 122, 124, 126 are under the physical control of and operated by a local vending machine operator 130. The local operator 130 is responsible for keeping the vending machines 120, 122, 124, 126 full and in service. In addition, the vending machine operator 130 is responsible for collecting the coinage or other payments from the machines and collecting and providing sales data to the appropriate party along with payment of the agreed upon commissions.

Vending machines 120, 122, 124, 126 are provided with a means for tracking the sales of the vending machine 120, 122, 124, 126. In an embodiment, the vending machine 120, 122, 124, 126 may be provided with an electronic data collection system that collects all sales data. Alternatively or in addition, the sales data may be collected in part by a human agent, for example by reading or recording sales data. Electronic sales data may be collected in any standard, format or conform to any protocol now known or later developed.

One example of electronic sales data is “DEX” data. DEX stands for “Data Exchange” and is a standard protocol for use in vending machines by which data is captured in a certain file type with the machine's processor and memory, referred to as the vending machine controller (VMC). A handheld can then wirelessly or via an access port connect to the VMC and download this DEX file which captures cash transactions, meter readings and the spiral turns from the last time the machine was serviced. DEX is but one example of a protocol for electronic sales data and others can be found including the protocol known as DDCMP.

Sales data may be transmitted to the local vending machine operator 130 physically, electronically or via a combination of both. For example, a technician may use an electronic reader to down load electronic sales data from the machine 120, 122, 124, 126 and then physically transport the reader to the local operator 130 or wirelessly transmit the electronic data from the reader to the local operator 130. Alternatively but expensively, the electronic data may be wirelessly transmitted to the local operator 130 by each individual vending machine 120, 122, 124, 126. In yet another embodiment, the sales data may be physically recorded via a technician with pen and paper and the physical record transferred to the operator 130 for manual entry. Other methods are also possible.

Sales data may include information on the item sale level such as each item sold, the cost of each item, time and date of sale and the number of items sold. In addition, sales data often includes machine level information such as a machine identifier (e.g., a serial number, a name or some other identifier), a machine make and model, a current location identifier, a total sales number, a current date and a current time.

In the environment 100 shown, the vending machine operator 130 is responsible for handling the hard currency, and possibly other forms of payment, made by the customers to the vending machines 120, 122, 124, 126. The vending machine operator 130 is also responsible for paying a commission to another party for the right to place and operate the vending machines 120, 122, 124, 126 at the vending sites 110, 112, 114, 116. The commission may be a fixed commission on sales (e.g., a fixed percent of total sales) or some other, more complex payment structure that is related to the sales of the individual machines 120, 122, 124, 126. In addition, the individual items in the machines may have different vend prices and different commission rates. The commission may be payable to the retail chain owner 134 or to an intermediary such as the vending management company 132.

In the embodiments below, the commissions owed are communicated by a commission statement. The commission statement is generated by operator 130 for a given period and is provided to the appropriate party for approval and as evidence of the amount of commissions owed by the operator 130.

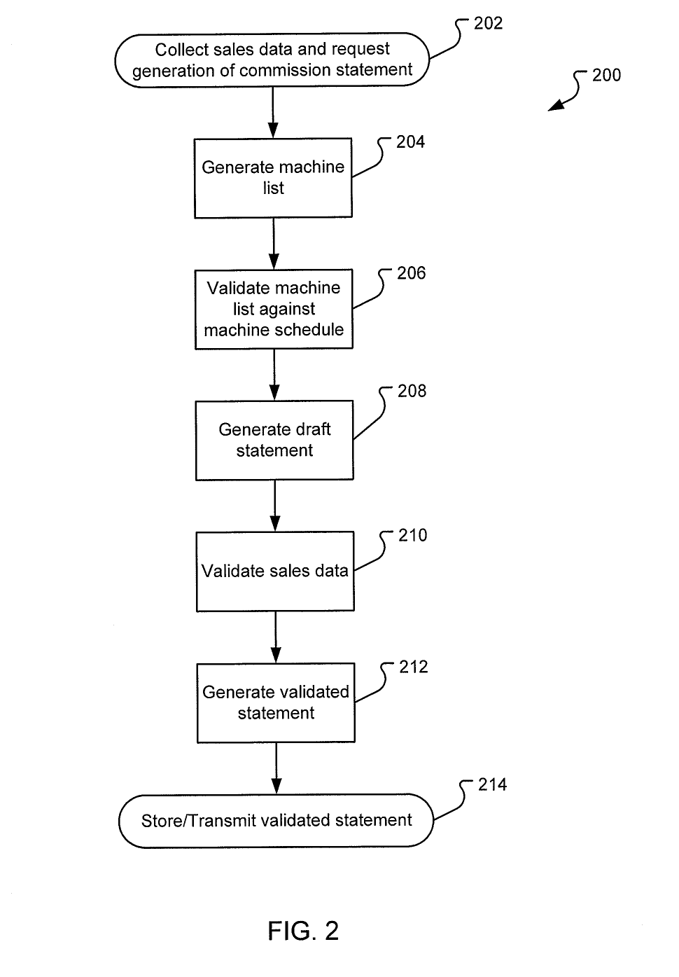

FIG. 2 illustrates a high-level embodiment of a method for generating a validated commission statement. The embodiment illustrated will be discussed in the context of a local vending machine operator that is generating a validated commission statement for submission to a vending management company. In an embodiment, the method 200 is performed by a secure computing system that is adapted to allow a computing device operated by the operator to obtain and access confidential information from a computing device used by vending management company. Embodiments of the system are described in greater detail below. One skilled in the art will recognize that the vending management company may be associated with, part of, or independent from the retail chain owner depending on the embodiment.

In the illustrated method 200, a local vending machine operator collects sales data for a given period from the various vending machines controlled by the operator, as illustrated by the collection operation 202. In an embodiment, the collection operation 202 may include collecting electronic sales data, collecting non-electronic data and compiling non-electronic data into an electronic form. The collected data is either maintained in a form that is accessible to the operator's computing device or must be manually entered in response to prompts received from the computing device.

After the sales data is collected, the vending machine operator issues a request to the system to generate a validated commission statement. Depending on the embodiment of the system, the request may be transmitted, via e-mail or through a browser, to a remote application running on the vending management company's computer. Alternatively, the request may be made to a local application on the operator's computer.

In response to the request, the system generates a machine list from the collected sales data, as illustrated by the generate machine list operation 204. The operation 204 includes accessing the operator's sales data in order to obtain the information necessary to generate a machine list. As many operators may be contracted to operate vending machines for different management companies, the generate machine list operation 204 includes identifying and retrieving only the sales data that is associated with the vending management company for which the commission statement is being generated. This may include searching the sales data for data associated with a previously determined client identifier.

In an embodiment, the generate machine list operation 204 results in the creation of a machine list of all the vending machines that were at vending sites associated with the vending management company during a given period. In an embodiment, some or all of the machine list may be automatically generated from the collected sales data. For example, the operator may be using only vending machines that are equipped with electronic data recording systems so that the data may be easily collected and managed by a software application. Alternatively, the operator may be using many different data recording systems and formats and the sales data may need to be manipulated or entered by hand in order to generate the machine list.

The machine list is then validated in a machine list validation operation 206. As described in greater detail below, the machine list validation operation 206 includes obtaining a validation schedule, also referred to as a machine schedule, from the vending management company and comparing the machine list to the machine schedule. If the comparison identifies discrepancies between the machine schedule and the machine list, the discrepancy is brought to the attention of the operator.

The machine schedule contains data related to what the management company expects to see in the commission statement from the operator based on the last validated commission statement received from the operator. The machine schedule is discussed in greater detail below. The actual data that may be included in the machine schedule may be different depending upon the embodiment. In the embodiment described in FIG. 2, the machine schedule includes data that identifies the vending sites and the vending machine for each vending site that the management company expects to see accounted for on the commission statement. The expected vending sites are those that the management company has identified as within the operator's responsibility and the expected vending machine is that machine that the operator listed as being in the expected vending site at the end of the period of the previous validated commission statement. The machine schedule may also contain data that reflects any changes to the operator's contract (e.g., adding or removing vending sites from the operator's service due to changes in the contract).

Discrepancies displayed to the operator may include expected vending sites or machines which do not appear in the machine list. Discrepancies may also include vending sites on the machine list that do not appear in the validation schedule. In an embodiment, the operator may have the ability to the correct any discrepancy by entering additional information, by entering an error code, or by changing information. Information may be changed on the root electronic sales data and the validation can be rerun. Alternatively, the operator may be allowed to modify data in the generated machine list.

In the embodiment shown the machine list validation operation 206 is complete when the operator has corrected all discrepancies. In an alternative embodiment, the operator may be able to delay addressing the discrepancies until some later time. In that embodiment, the validation operation 206 may be completed after all of the discrepancies have been identified and upon receipt of the operator's request to generate the draft commission statement with the discrepancies for later resolution.

It should be noted here that there are alternative ways of verifying that the data in the data sources match the machine schedule that do not include first generating a machine list as described above. Thus, the machine list operation 204 and validation operation 206 as described are but one embodiment of verifying the operator's data against the data maintained by the management company. The reader will understand that any suitable method for performing such a verification may be used.

After validation, the machine list is then used to generate a draft commission statement in a draft statement generation operation 208. In an embodiment, the draft statement generation operation 208 creates a draft commission statement that includes the vending sites and vending machines listed in the machine list and those expected vending sites and vending machines contained in the validation schedule that are not listed in the machine list.

In the operation 208, the information from the machine list, which may have been modified by the machine list validation operation 206, is combined with the collected sales data related to the sales of each listed machine, to create the draft commission statement. The sales data may have been retrieved during the generate machine list operation 204, may be retrieved in this operation 208. In addition, the sales data may be retrieved multiple times, for example to obtain sales data for expected vending machines that were not on the original machine list.

In an embodiment, the draft commission statement may include a list of vending sites that includes the expected vending sites, one or more vending machines for each site and, for each machine, a specified period of time (which may be smaller than the given period for the commission statement) during which the machine was at the specified vending site. In addition, the draft commission statement may include sales data for each machine during the period it is identified as being at each vending site. The draft commission statement may further include commission rates and calculation of the commissions due for the period of the commission statement. Such commission rates may differ by machine, vending site, total sales, etc. and the different rates may be provided within draft commission statement by machine, vending site or other metric.

The draft commission statement is then validated in a second validation operation 210. In the second validation operation 210 the draft commission statement is analyzed against a set of predetermined criteria. Errors may be reported to the operator, to the management company or both if the draft commission statement does not meet the predetermined criteria.

Criteria may include simple conditions such as whether sales data has been provided for each vending machine, whether each vending machine is listed at a valid and the correct vending site; for each time period entered whether the time period is within the time period covered by the commission statement.

Criteria may also include verifying that the collected data comports with data provided by the vending management company. For example, each commission rate in the draft commission statement may be verified against the commission rate in the vending management company records. In addition, the sales data for a vending site for the period of the commission statement may be compared to historical or other information maintained by the vending management company. Such information from the vending management company may be provided in a second retrieval operation or may have been provided with the machine schedule at the time it was requested by the system.

In an embodiment, if errors are reported in the second validation operation 210, the operator may be prompted to correct the errors or alternatively, may be allowed to save the draft commission statement and resolve the errors at a later time. The draft commission statement, however, cannot be finalized until all the errors are resolved. As discussed above, resolving the errors may require changing data, adding information, providing an error code or some other action on the part of the operator.

In addition, for embodiments in which a draft statement may be generated before all discrepancies identified by the machine list validation operation 206 have been resolved, the second validation operation 210 requires resolving those discrepancies as well. In an embodiment, if machine list discrepancies remain, the operator is prompted to resolve them and the second validation operation 210 cannot be completed until a resolution is obtained.

After the errors have been resolved, the draft commission statement is validated and a final commission statement is generated in a final statement generation operation 212. The final commission statement may include information generated by the system that indicates to the vending management company that final commission statement was, in fact, verified and not generated by hand or through some other means. This allows the vending management company to be confident in the data supplied in the final commission statement and to focus on resolving the error codes supplied by the operator.

The final commission statement may then be transmitted in a transmission operation 214. The transmission operation 214 may occur automatically upon validation or in response to an operator command received some time after the final statement is generated. The transmission operation 214 may include a secure, point to point transmission between the software application on the operator's computing device and the application on the vending management company's computing device. Alternatively, the final commission statement may be e-mailed, stored on media and physically sent, or otherwise transmitted to the vending management company.

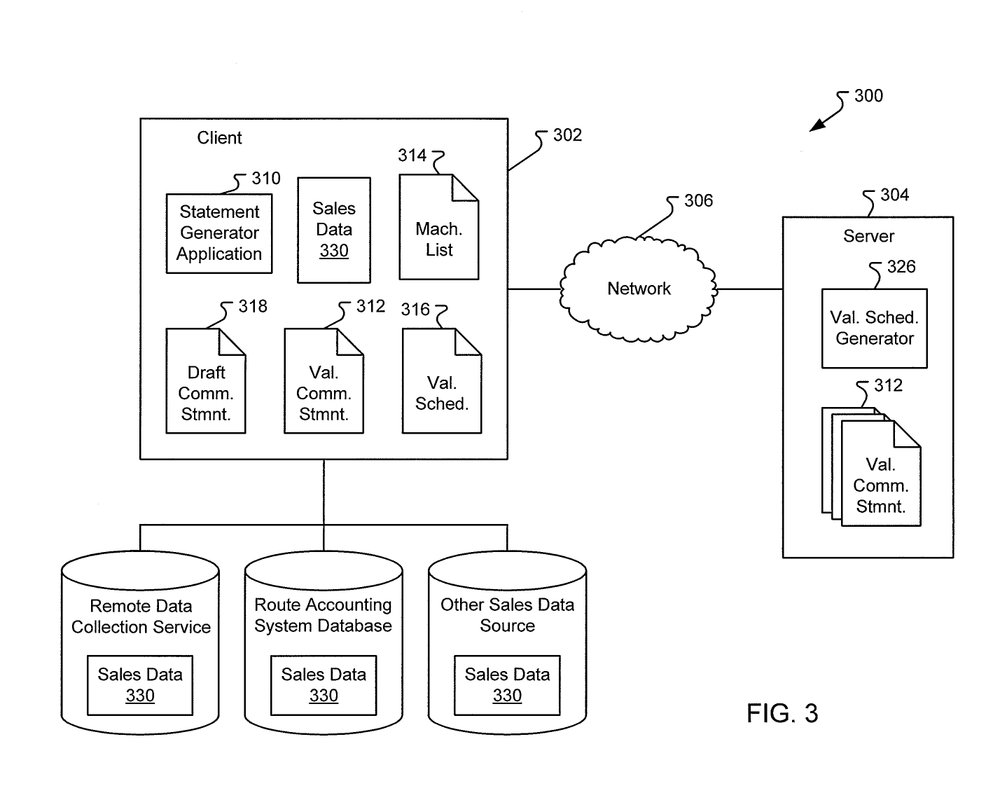

FIG. 3 illustrates an embodiment of a client-server system for generating a commission statement. In the embodiment shown, the local vending machine operator is provided with a client computing device 302 that is adapted to communicate, via a network 306, with a computing device 304, referred to a server because it responds to requests from the client device 302. The server 304 may operated by the vending management company, the retail chain owner or any other party responsible for verifying the accuracy of the commission statement.

In the embodiment shown, the client 302 and server 304 may take the form of one or more computing devices that include a processor and memory for storing data and software as well as means for communicating with other computing devices, e.g., a network interface module. Computing devices may be provided with operating systems and may be adapted to execute software applications in order to manipulate data and communicate with other systems. Alternatively, some or all of the various elements could be combined on a single computing device and performed by one or more software applications that perform the functions described elsewhere herein. Computing devices are well-known in the art and examples of computing devices include personal computers, smart phones, personal data assistants, servers and mainframes. One skilled in the art will recognize that although referred to in the singular, a computing device may actually consist of a plurality of computing devices that operate together to provide data in response to requests from other computing devices.

In a computing device, local files, such as media files or raw data stored in a datastore, may be stored on a mass storage device (not shown) that is connected to or part of any of the computing device. A mass storage device and its associated computer-readable media, provide non-volatile storage for the computing device. Although the description of computer-readable media contained herein refers to a mass storage device, such as a hard disk or CD-ROM drive, it should be appreciated by those skilled in the art that computer-readable media can be any available media that can be accessed by the computing device.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

It should be understood that while the network 306 shown in FIG. 3 is the Internet, a global internetwork of networks in common use today, other networks can be substituted therefor. For example, network traffic over the Internet can travel through public networks and is largely based on TCP/IP (Transmission Control Protocol/Internet Protocol) packet switching. However, the embodiments of the invention shown herein might also be used on networks that are not public, such as intranets, extranets, and virtual private networks. The embodiments might also be used with WAN's, LAN's, WAN/LAN couplings, wireless connections, mobile links, satellite links, cellular telephone networks, or any other network where responsiveness is a concern. In addition, while TCP/IP is the most common packet switched protocol today and thus serves as a good example, other network protocols might be used (Ethernet, etc.). As for overlying protocols, the clients and servers described herein (and peers, as described below) might use HTTP, FTP, SNMP, POP3, IMAP, SMTP, NFS, CIFS, RPC, or other open or proprietary protocols for transport of data.

In the embodiment shown, the client 302 is provided with a software application 310 that can communicate with the server 304. In an embodiment, the application may be obtained directly from the server and installed by the operator.

For example, the operator may install the application by clicking on a previously provided URL, which will download the installer and launch an installation process. The installer may then require that the operator accept an End User License Agreement (EULA) before installing the software. Once the software is installed, the operator may launch the software for the first time. On the first launch of the application, the operator may be required to enter an application key or perform some other action to verify the identity of the operator and that the operator should be able to access the server 304. This authentication may include such actions as providing a code, a username or a password. Upon authentication, the server 304 records information about the client 302 that made the connection. From that point on, the authentication information (e.g., specified application key, user name, and password) can only be used with this installation (meaning, this client 302 machine, for this operator). This prevents the situation in which another operator might obtain an application key or other authentication information that was not meant for them: application keys only work for the operator and one specific client 302 they are associated with. Once the first connection is successful, the client application 310 then may retrieve an operator identification number from the server 304 and store it locally, to be used in subsequent authentications.

The statement generator application 310 generates and ultimately validates a commission statement 312 in response to an operator request as described elsewhere in this disclosure. In the process of generating and validating the commission statement 312, the generator application 310 performs a set of operations through which the data in the commission statement 312 is validated. In an embodiment, various operations may generate separate and identifiable intermediate documents each containing data different attributes reflecting different stages of validation, such as those documents described with reference to FIG. 2. In an alternative embodiment, a single document may be created by the commission statement generator 310 and the data in the document is revised by each successive operation until a validated commission statement 312 is obtained. Regardless of the embodiment, however, for the purposes of this disclosure the intermediate documents will be referred to by different names in order to assist the reader in differentiating the different stages of validation.

The statement generator application 310 generates a validated commission statement 312 based on the accessible sales data 330 and validation data provided by the server 304 in a series of steps. In the embodiment shown, the first step is searching the sales data 330 in order to generate the first intermediate document referred to as the machine list 314 as described elsewhere. The machine list 314 contains a list of vending sites, and any vending machines at those vending sites for the period in question, contained in the sales data 330 that are associated with the vending management company. In an embodiment, the sales data 330 includes a client identifier for each vending site and the application 310 identifies the sales data 330 associated with the vending management by searching for data associated with the client identifier.

The machine list 314 is initially generated by the client application using data obtained from one or more data sources 320, 322, 324. Data sources 320, 322, 324 may be external systems or datastores, such as traditional route accounting systems 322, remote data collection sources 320, or manual entry data sources 324 from operators. The data sources 320, 322, 324 may also be local data sources. The application 310 may be adapted to receive or retrieve data from any source of sales data 330 including via manual entry of machine sales totals, from traditional route accounting systems, from local databases or spreadsheet files, from remote data collection providers, and/or from any other data sources.

In an embodiment, the machine list 314 may also contain more data associated with each listed vending site. For example, the machine list 314 may contain the individual machine vending sales data for each vending machine listed in the machine list 314. In an alternative embodiment, the individual machine vending sales data may be retrieved from the sales data 330 in a later operation.

It should be noted that depending on how the machine list 314 is structured, a particular vending site may appear multiple times in the machine list 314. This may occur, for example, if during the period in question the original machine was replaced with a different machine. In an alternative embodiment, the machine list 314 may be structured so that each vending site is listed only once, but may be associated with more that one vending machine for different time periods. As long as the machine list 314 contains the appropriate data, the structure chosen is an matter of preference on the programmer's part and any suitable data structure or format may be used. In general, this holds true for all documents described herein. As noted above, generating a machine list 314 is but one way to verify the sales data 330 against the contents of the validation schedule 316. In an alternative embodiment, a machine list 314 need not be created, the verification being performed by some other method. However, the machine list 314 is described herein in detail as it is helpful in illustrating the verification operations.

A second intermediate document is the validation schedule 316. As part of the validation process, the application 310 requests and receives the validation schedule 316 from the server 304. The server 304 includes a validation schedule generator 326 that dynamically retrieves validation data from data sources accessible to the server including, for example, validated commission statements 312 for previous periods generated by the application 302 in the past. As described elsewhere, the validation schedule 316 contains validation data transmitted to the application 310 by the server 304. The validation schedule 316 contains data that indicates what data the management company expects to be contained in the commission statement 312 if the commission statement 312 is to be reconciled with the previously submitted commission statements. In an embodiment, the validation data includes a list of vending sites the management company expects the operator to provide data for and pay commissions on for the period in question. In addition, the validation data may identify the vending machine that was identified as being at each vending site at the end of the previous reporting period. The validation data may also include sales data for vending sites derived from prior commission statements to be used for comparison with the current data. The validation data may also include a commission rate or other commission data for each vending site. Other historic data may also be provided as described elsewhere in the disclosure and depending upon the validation requirements of the management company.

The machine list 314 and validation schedule 316 are compared and a third intermediate document may be created referred to as the draft commission statement 318. The draft commission statement 316 contains the vending site and vending machine data of the machine list 314 and also includes any expected vending sites and their associated vending machines that are contained in the validation schedule 316 but are not found in the machine list 314. The application 310 during the validation process requires that such expected, but missing from the machine list 314, machines and vending sites be accounted for.

In an embodiment, the validation may be performed by verifying that each vending site on the validation schedule 316 is contained in the sales data 330 and then verifying that the appropriate (i.e., expected) machine is listed for that site. Alternatively, the validation may be performed by checking to see if each expected machine is listed in the data 330 and then verifying that each machine is located at its expected vending site. The reader will understand that the exact method of validating the data in the validation schedule 316 against the data 330 may vary depending upon choices made by the developers of the systems and that any suitable validation methodologies may be used. Regardless of the exact methodology, the validation includes verifying that each expected machine appears in the data 330, that each expected site also appears in the data 330 and that each particular expected machine-site combination on the validation schedule 316 appears in the data 330.

During the process of comparing the machine list 314 and the validation schedule 316 and generating the draft commission statement 318, the expected but missing vending sites may be identified as discrepancies and the discrepancies communicated to the operator for correction. Likewise, after comparing the vending sites, any discrepancies between vending machines listed at a vending site in the machine list 314 and the expected vending machine listed for the same vending site in the validation schedule 316 may be identified. These discrepancies may also be communicated to the operator for correction. Any discrepancies may also be flagged in the draft commission statement 318.

In an embodiment, the draft commission statement 318 also includes the individual machine vending sales data obtained from the sales data 330 collected by the operator. The draft commission statement 318 may also include the commission rate associated with each vending site and a calculation of the commission owed based on the vending sales data using the commission rate. More or less data may also be included in the draft commission statement 318 depending on the various validation operations to be performed.

In an embodiment, the draft commission statement 314 is relatively complete so that it can be reviewed as a stand alone document by the operator. The draft commission statement 318 may be saved by the application 310 in response to a request from the operator and retrieved later for continued processing.

In an embodiment, some or all of the documents described above may be generated in the form of an XML document based on an XML schema that defines the data elements in the document. For example, in an embodiment the XML document may contain the following parts, in a hierarchical fashion:

The statement level data

The message header

The operator sales header

The owner sales header

The site sales header

The machine sales header

The machine line item

At the statement level, the XML document may contain the name and optional notes (provided by the operator when the statement was generated), as well as date-time information describing the period in question, when the statement was created, the status of the statement, and the date-time when the statement was sent to the server (if applicable). The statement contains a single message header.

At the message header level, the XML document may contain a unique identifier for the statement, based on information about the operator, the period, and the date-time it was generated. Identifiers are also provided for the operator generating the statement and the type of message being generated (in this case, a validated commission statement). The message header also contains a single operator sales header.

At the operator sales header level, the XML document may contain the name and identifier for the operator and the sales totals for the operator. It may also contain a list of zero or more retail chain owner sales headers if the operator is responsible for different vending sites owned by different owners but managed by the same management company.

At the owner sales header level, the XML document may contain the management company identifier for the owner and the sales totals for the owner. It also contains a list of zero or more site sales headers.

At the site sales header level, the XML document may contain the management company identifier for the vending site (location), and the sales totals for all vending machines at the vending site during the period in question. It may also contain specific information about the site, such as name and address. It may also contain a list of zero or more machine sales headers.

At the machine sales header level, the XML document may contain the management company identifier for the machine, and the sales totals for all items sold by the machine. The machine sales header may contain make and model information about the machine, as well as date-time information about the report dates, the number of DEX readings (and missing DEX readings), as well as the body of the first and last DEX of the period, when available. It may also contain a list of zero or more line item headers.

In an embodiment, the line items contain sales totals for a specific item (including the item code) for that period (for the specified machine).

Commission rate and a commission calculation may be performed at any appropriate level (e.g., at the line item level, the site sales level, or the owner sales level).

The above described document format is but one example of a suitable document format and various types of data that may be included in a commission statement. Any other format may be utilized at the discretion of the developer. In addition, depending upon the embodiment, more or less data and types of data may be included as necessary to meet the needs of the management company.

However, the format described above is adapted to lend itself to a simple stepwise validation algorithm. The validation process occurs by stepwise comparing each client code found in the validation schedule 316 with the client information in the machine list 314 (generated by a union of all machines returned by the specified external systems). If the client exists, then the comparison moves to the site level and then finally to the machine level. If, at any level, the validation data in the schedule 316 are not represented in the machine list 314, then the data is created, added to the machine list 314, and flagged as having been created from validation data. For machine sales headers, this means that the machines will have zero sales information, and must be accounted for.

In an embodiment, the validation process occurs twice for each validated statement 312 that the application 310 generates: first, based on the machines returned from the external systems but before the draft statement 318 can be viewed; second, after the sales information is collected from all external systems, just prior to the draft statement 318 being able to be saved locally for review. At both validation steps, the operator may be presented with a visual list of any problems with the statement data, including both warnings and errors. In an embodiment, the list of exceptions can be shown in the form of an exception report as well, which may be generated in any suitable format such as a TXT, PDF or DOC format.

Within the XML format for the statement, at the machine level, additional information may be included that specifies where the individual machine vending sales information was collected from. For example, information may be provided that indicates that this vending machine appears in the document because it was listed in the validation schedule 316 but not found in the sales data 330. No sales information was provided by data sources 320, 322, 324 about this machine, so the operator provided an explanation of this in narrative or in the form of an exception code. All information about the machine is based on the information in the validation schedule 316, with the exception of the explanation.

Information may also be provided to indicate that the individual machine vending sales data was provided from electronic sales data 330 obtained from a trusted external system. For example, one of the accounting systems 320, 322 that were communicated with during the statement generation process provided machine sales information about this machine. The system in question is mentioned explicitly so it can be identified at the server 304. If both a local accounting system and a remote provider return sales information about a machine, the remote provider takes precedence, and so it is the remote provider that would be mentioned in this place as the source of data for the machine.

Information may also be provided to indicate that the individual machine vending sales data was provided by manual entries from the operator. The operator did not explain the missing sales totals for the machine using a provided exception code, but instead manually entered the sales totals for that machine based on some external tracking that could not be automatically contacted as part of the statement generation process.

In an embodiment, the XML format for statements serves two purposes within the system. First, statements can be generated and stored locally as encrypted files. This allows them to be viewed later for reporting purposes, but the files cannot be modified except via the application 310. Second, the statement files can be transmitted to the server 304 via a Web Service provided for that purpose. During transmission, these files remain encrypted, until they reach the server 304.

Returning now to the server 304, in an embodiment the server 304 and client 302 communicate via a web service that provides operations for client authentication, administration, and the retrieval of machine schedule information. This web service provides the following operations:

Password change—allow the operator to initiate a password change that will update the value on the server.

Get schedule—retrieve the validation schedule for a given period.

Validate user—validate that the user name and password provided by the user are the ones expected for this operator installation.

Validate application key—validate that the specified installation key is correct for this operator installation.

The server 304, upon receipt of a request from the application 310, generates and transmits the validation schedule to the application 310. In an embodiment, the request from the client 302 includes the specified period, year, and operator identification. As discussed elsewhere, the validation schedule 316 provides a detailed list of the vending sites and machines that the management company expects to receive commissions for, for that specified time frame. Only machine and site information for the specific operator will be returned to that operator. The preceding authentication steps, as well as the need to once again identify the operator making the request, prevent the data from being retrieved by another operator. In addition, the schedule 316 is transmitted to the client application in an encrypted form, using operator-specific values to encrypt the information. This means that only the application 310 installed for a specific operator can decrypt the schedule information for that operator.

In an embodiment, the validation schedule 316 is retrieved from the management company server 304 as part of the generation of a new statement. Once a schedule 316 has been retrieved for a specific period, it may be stored locally on the client machine 302 as an encrypted file to prevent operators from modifying its content. If for some reason the statement must be generated more than once, the schedule does not need to be retrieved additional times, although it can be. The application 310 will use the previously downloaded schedule 316 when available.

The validation schedule 316 provides information about each machine expected to appear for a given operator. The information provided for each machine may include the client and site identifiers, the address of the site, the identifying information for the machine, the commission rate for the machine, and sales information about that machine for the same period of the previous year.

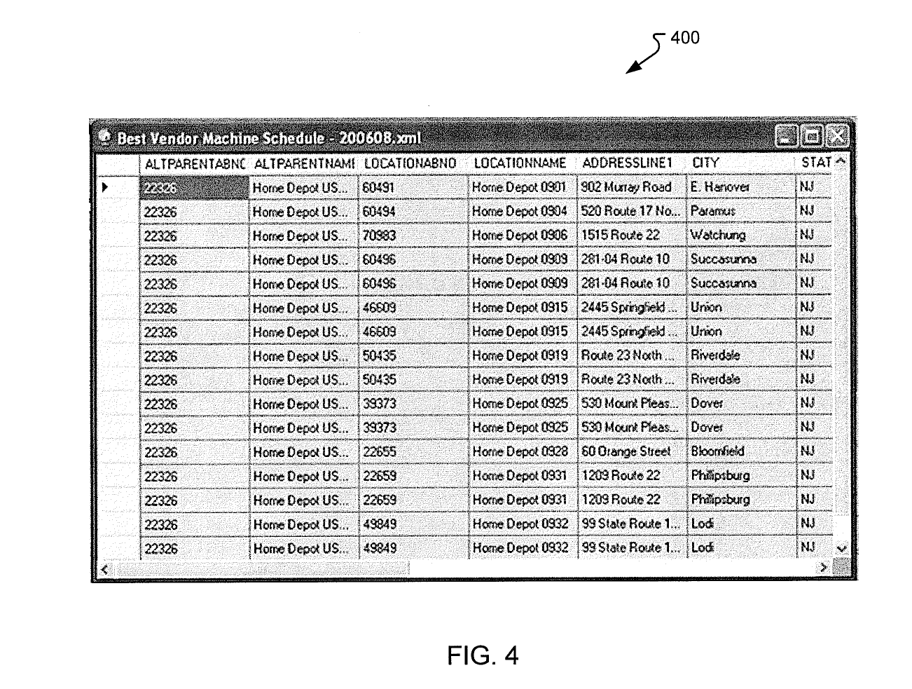

In an embodiment, after a validation schedule 316 for a given period has been downloaded and stored locally, it can be viewed from the client application. FIG. 4 is an embodiment a decrypted validation schedule as displayed to a user by the application 310.

In an embodiment, the application 310 and the validation process do not allow a draft commission statement 318 to be generated until all machines that are expected (meaning that they appear in the machine schedule for that period) either:

Have sales totals that came from an external system

Have sales totals that have been entered manually by the operator

Have an approved reason code explaining the lack of sales information

In addition, all machines must appear at the vending site as shown by the validation schedule 316. If there are any conflicts in the machine's site, they must be addressed outside of the application 310 (such as by using an interface to the external system that provided the information, or having the management company modify the validation schedule information) before the draft commission statement 318 can be generated. The above described conditions may be considered “hard errors” by the system in that they will prevent the draft commission statement 318 from being generated for the period.

In an embodiment, in addition to the hard errors, there are a number of “soft error” or “warning” conditions that can result in messages being raised to the operator and/or added to the statement 318, but still allow the statement 318 to be generated and validated. Examples of soft error conditions include:

The commission rates in the machine schedule do not match the rates returned by the external system

The difference between the gross and net sales for the machine exceed a specific percentage of the gross sales

The sales for the machine for this period differ too greatly from the sales for the same machine for the same period of the previous year

In an embodiment, whenever the operator provides additional information about a machine during the validation process, this information may be stored in the downloaded machine schedule for that period. This allows the operator to start the validation process, account for a portion of the machines in error, and then leave the system in order to address other issues before completing the statement generation process, while still retaining all their work. If for some reason the machine schedule is downloaded again for the same period after it has been successfully downloaded once, the machine schedule for that period may be overwritten, thus eliminating any reason codes or manual sales information entered by the operator for that period.

The application 310, in addition to being responsible for the creation of the various documents using external systems and transmitting validated statements 312 to the server 304, it is also adapted to generate reports based on the generated documents.

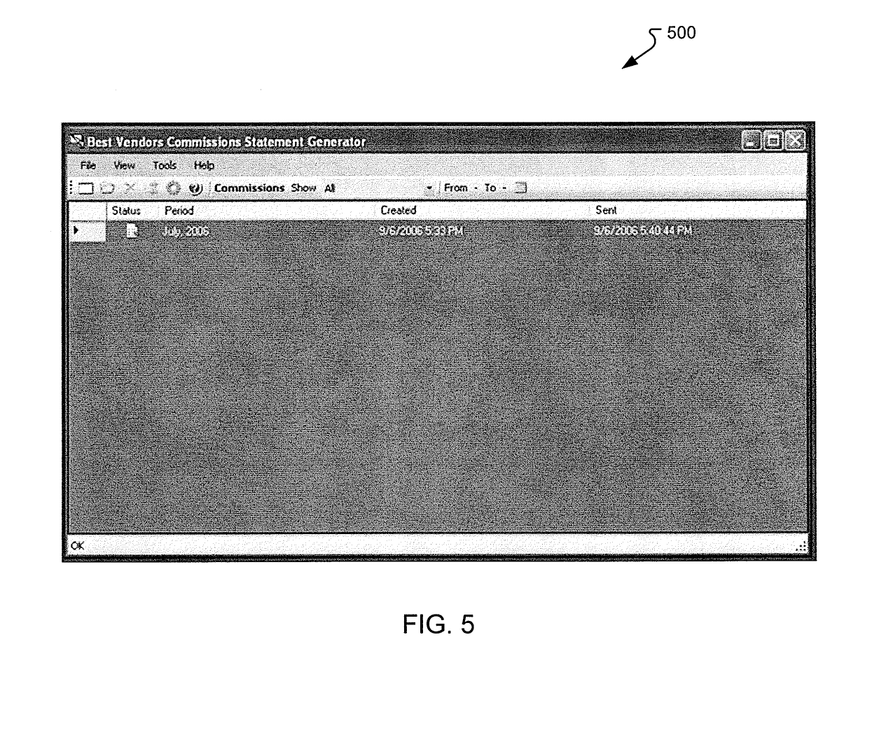

FIG. 5 illustrates an embodiment of a graphical user interface displayed by the application 310. The interface 500 displays a list of all the commission statements documents that have been generated on this machine. The list may be filtered using a date range comparison to the creation date of the statement document, and also it may be filtered based on the status of the document (sent vs. unsent). The operator may view a commission statement report (see below) by selecting the statement from the list, or by using the menus of the application. The operator may send statement documents that are currently unsent from the main screen. The operator may also start the process of creating a new statement, or may delete an existing statement, assuming that the statement for that period has not already been submitted to the server for processing.

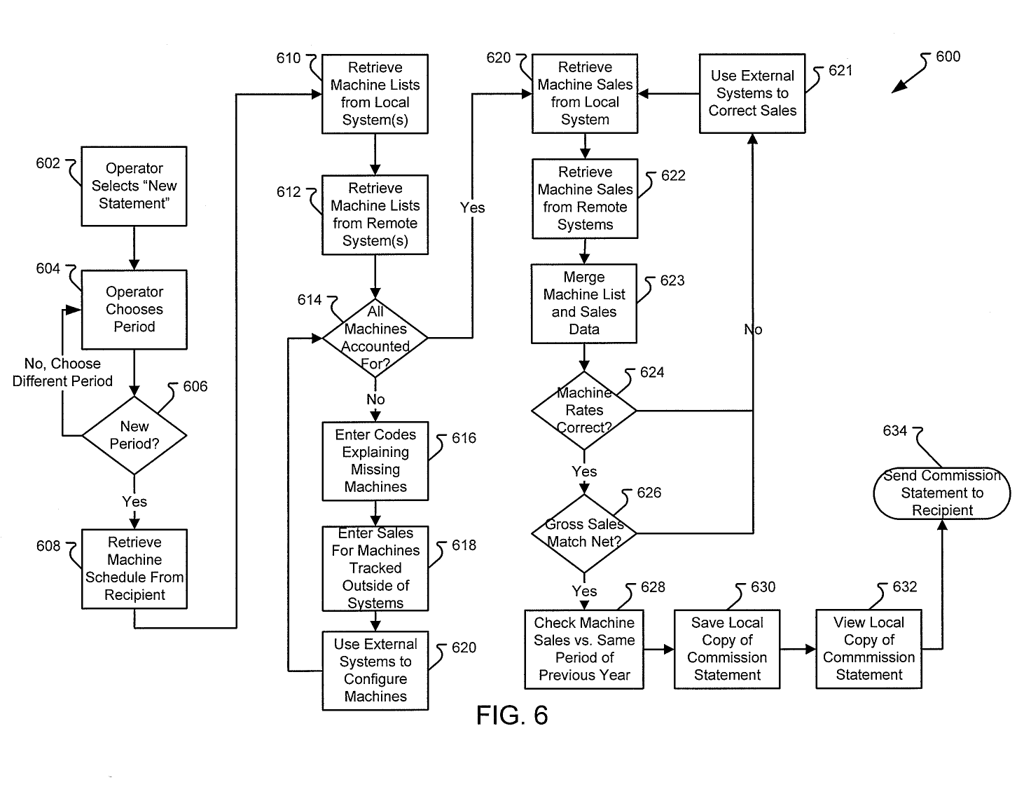

FIG. 6 illustrates another embodiment, in greater detail, of a method for validating a commission statement. From the main window of the application, operators can start 602 the statement generation method 600 using either the toolbar or menu items. In the embodiment, the method 600 starts when the operator requests 602 the application to begin generation of a new commission statement.

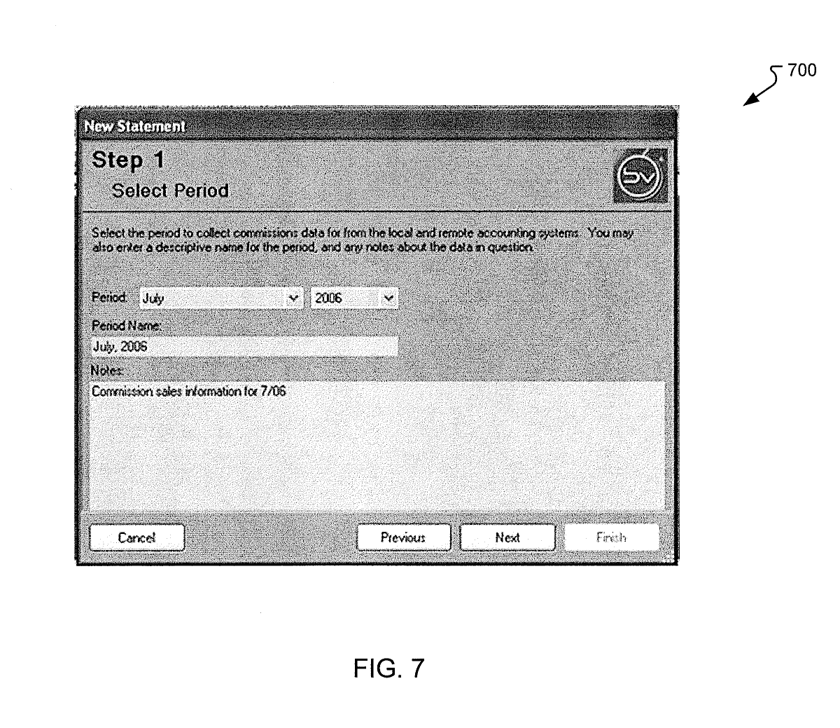

Next, period selection is performed. In the period selection, the operator selects 604 the calendar period that should be used for commission statement generation. Only closed periods (i.e., periods in the past) are available to choose from. The period selected is then checked 606 against data either at the client computer or retrieved from the server. Attempting to select a period that has already been submitted to the server will result in an error message. FIG. 7 illustrates an embodiment of a user interface displayed to a user as part of the period selection operation. Note that the period used may be any period defined by the operator or other party and need not be a regular calendar period.

The validation (machine) schedule is then retrieved 608. The machine schedule is downloaded from the server using the operator and period information. If the schedule already exists locally, it is not necessary to download a new version (this may occur if the statement is generated multiple times before submission to the server).

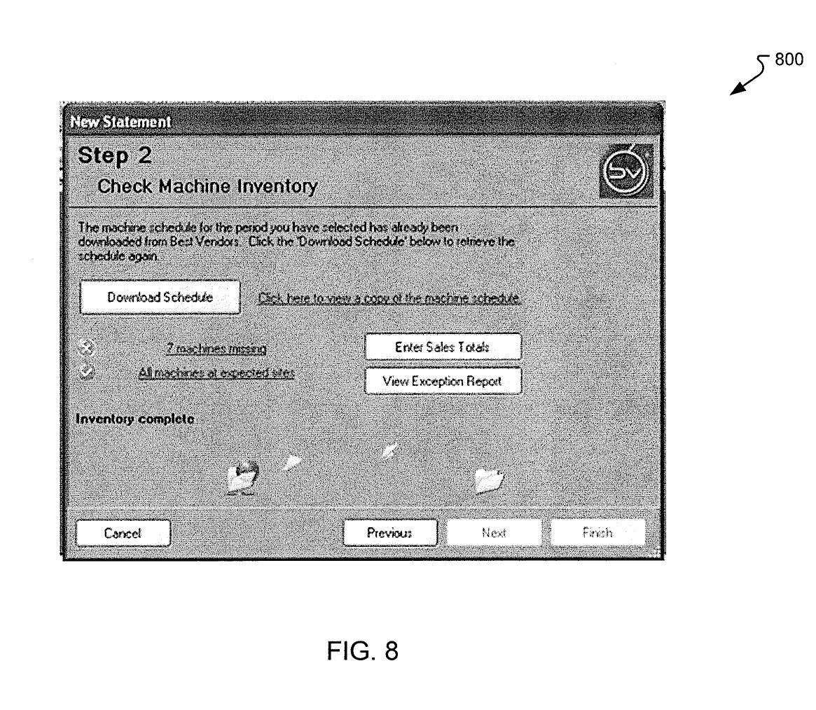

FIG. 8 illustrates an embodiment of a user interface displayed to a user as part of the validation schedule retrieval operation. The interface includes a control button that causes a request to be sent to the server, which responds by generating and transmitting the validation schedule to the application. FIG. 8 also includes information generated by the validation operation 614 discussed below.

Next, the machine list is retrieved or otherwise generated from sales data contained in the local 610 and external systems 612. The list of machines that will be returned for that period is gathered from each of the external systems, using the integration libraries that allow the application to access and interpret the data in the systems. The individual lists are merged into a single machine list that represents the union of all the systems, both local and remote.

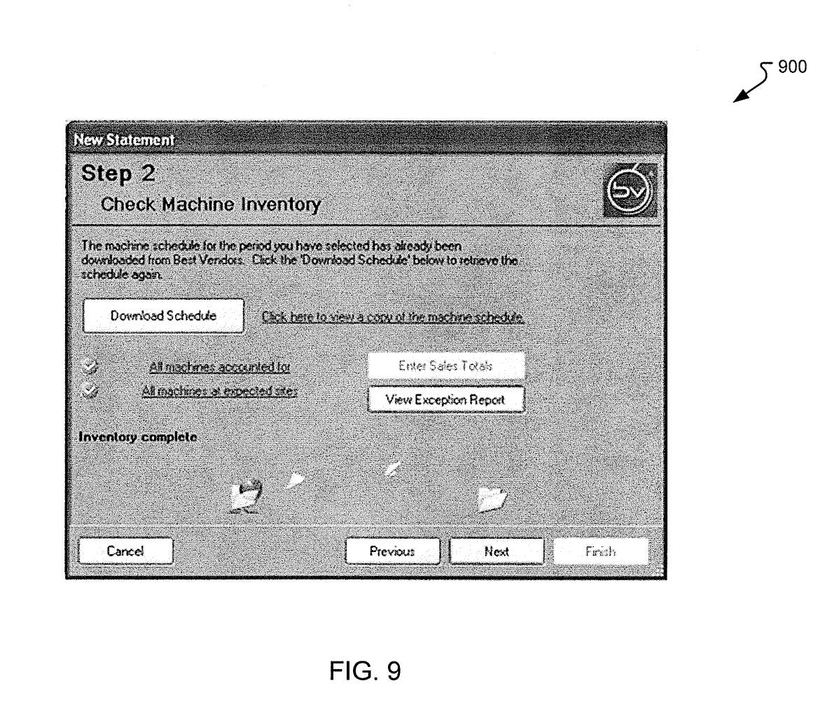

The machine list is then validated against the machine schedule. The application compares 614 the machine list derived from the sales data with the machines and other data in the validation schedule as described above. When discrepancies are found, validation errors and warnings are displayed on the screen illustrated in FIG. 8 as shown. These discrepancies include an expected machine on the validation schedule that does not appear on the machine list; an expected machine on the validation schedule that does appear on the list, but only appears at an unexpected site(s) (taking into account that a machine may appear at more than one site in a period); a site that is not an expected site (i.e., a site for which commissions are not owed to the management company); and an expected site that does not appear on the validation schedule. These error conditions are described in detail elsewhere. When the validation process 614 is successful, which may not occur until additional accounting steps have been taken, the screen reflects this and allows the user to continue with the process of creating a new statement. FIG. 9 illustrates an embodiment of a user interface displayed to a user upon verifying that the vending machines in the machine list match the data in the validation schedule. In an embodiment, the process cannot proceed to the steps where sales information is retrieved and merged until all machines are accounted for during validation.

If the validation is not successful, in addition to alerting the user the method 600 accounts for any inconsistencies found during validation. The user may be allowed to enter 616 predetermined exception codes known to the system that are associated with an explanation of why the machine is missing. The user may also be allowed to manually enter 618 sales data for specific machines. The user may also be allowed to use 620 the external systems to modify the sales data after which the revised sales data may be retrieved and the machine list revised.

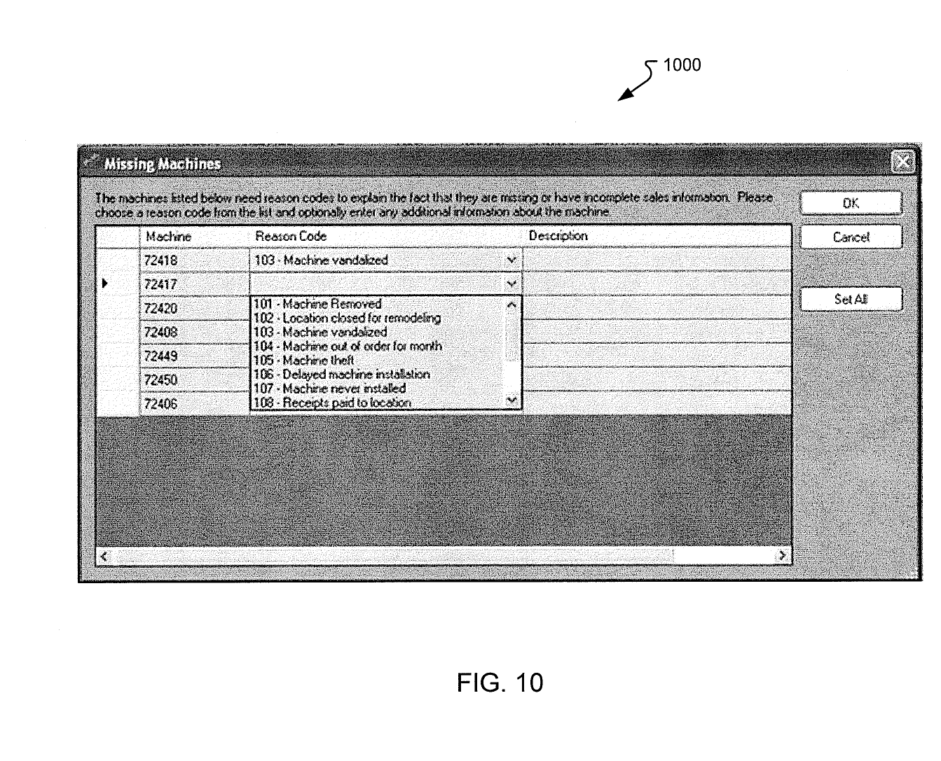

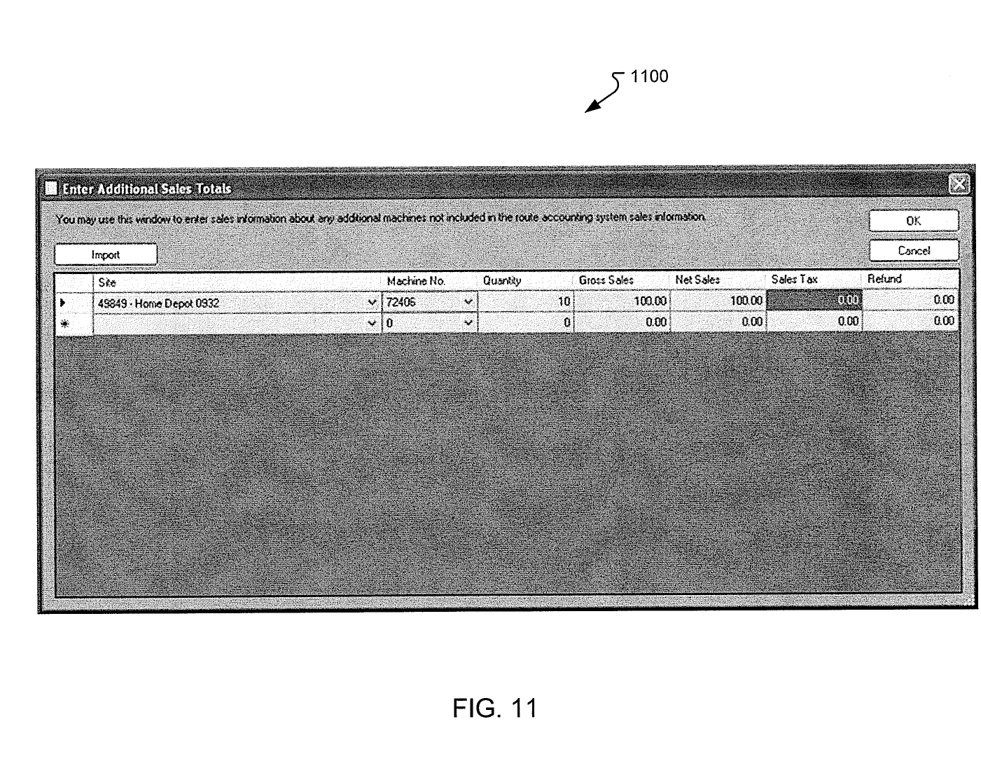

The application provides screens to allow the operator to account for validation errors. The Exception Code form (FIG. 10) allows the operator to select from a list of pre-approved reason codes to explain missing sales information for a specific machine, and provide additional notes on the reason if necessary. The Manual Sales Entry form (FIG. 11) allows the operator to enter in the sales totals for a given machine manually, or import them from a comma-separated (CSV) file. Additional accounting and resolution steps may need to occur in the external systems themselves, but any accounting that the operator does within the client application is persistent between sessions of the application.

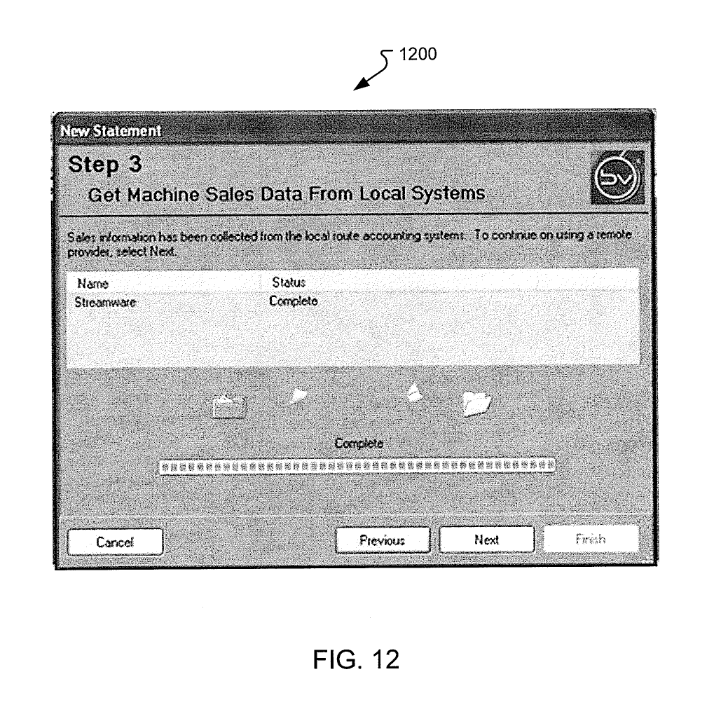

Next, the method retrieves 620 the machine sales information from local route accounting systems (FIG. 12). The application can connect to any designated local route accounting system using the installed integration libraries or other data access technology. For example, in an embodiment the integration library is loaded, the data provider is activated, and the commission statement data is retrieved.

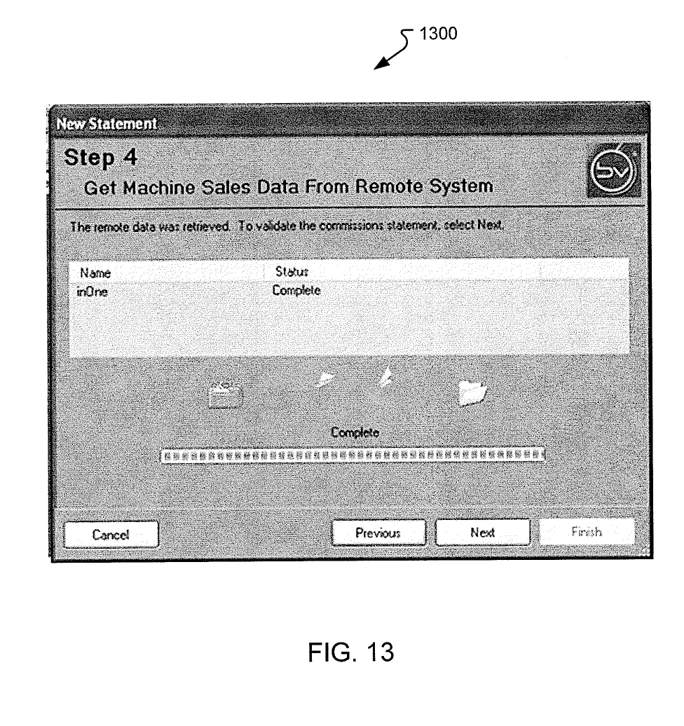

The method then retrieves 622 the machine sales information from remote data collection systems (FIG. 13). The client application can connect to any designated remote data collection systems using the installed integration libraries or other data access means.

The machine sales information is then merged 623 into the machine list to form the draft commission statement. The data collected in operations 620 and 623 above are merged into a single set of commission statement data. The draft commission statement is the union of all the collected sets of information. In an embodiment, if a machine appears in multiple data sources (for example, in both a local route accounting system and in a remote data collection system), the sales information in the remote data collection system takes precedence over any other data.

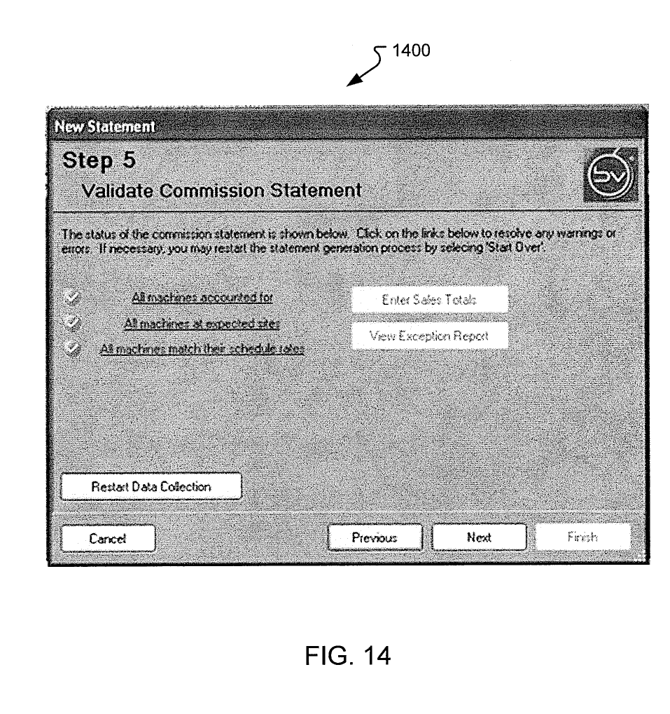

The method 600 then validates 624, 626 the resulting merged statement (FIG. 14). The second validation 624, 626 occurs after all the sales information is retrieved from the external systems and merged. This validation process is a superset of the initial validation process, and also compares 624 commission rate information, compares 626, 628 gross sales and net sales and sales for the previous year's period for a vending site to determine if they are within predetermined variances. In an embodiment, additional validation steps are warnings, not errors.

The method allows the user to save 630 the commission statement as a local XML document. This may be at the user's discretion or may be performed automatically. Once the entire process is complete and the second validation operations 624, 626 are successful, the validated commission statement is saved locally as an encrypted XML document. This document can then be reviewed 632 and later, if it meets the operator's approval, submitted 634 to the intended recipient for processing.

Once the operator has generated a commission statement, viewed the statement reports, and is comfortable with the resulting commission calculations, it is then possible to submit 634 the commission statement XML document to the recipient for processing. The user can select to submit a statement XML document that is stored locally, as long as the document has not been already submitted to the server. Once a statement XML document has been submitted, the status of the document changes and it is no longer available to submit. If errors occur during the submission, the statement XML document will be set to an error status, which will be indicated to the operator.

In an embodiment, Whenever a statement XML document is sent to the server, it is transmitted using a dedicated web service through which the application and the server communicate. The submission 634 may require the passing of identifying information about both the operator and client computing device. The statement XML document is passed to the web service as an encrypted block of data encrypted using specified secrets that have been stored server-side in relation to this operator and installation. This prevents anyone but the specific operator from communicating with the web service and submitting or retrieving data related to that operator.

Once a commission statement XML document has been successfully submitted to the server via the web service, it is stored on the server and set for processing. The XML document is stored both in decrypted form and in its original encrypted, raw form. The XML document may also be optionally stored in a set of relational database tables that model the structure of the commission statement data in a relational manner. In such a case, the XML message itself, in its entirety, can also be stored within the database structure and tied back to the sales information it contained.

Given the sensitivity of the data transmitted between the operators and Best Vendors for purposes of generating the commission statements, it is absolutely essential that sufficient levels of security are provided. Both the machine schedules and the commission statement XML documents that are stored locally on the client machine of the operator are encrypted using operator and installation specific information to perform the encryption. This prevents the data from being removed from this installation and taken to another for viewing or submission. When transmitted to or from the server, the schedules and statement XML documents are still similarly encrypted with operator and installation specific secrets for the encryption. In addition, in an embodiment, each use of the application requires the user to provide user credentials (e.g., user name and password). Each set of user credentials is only valid when used in combination with the application key or some other data element provided for that installation and with additional client-specific data.

Those skilled in the art will recognize that the methods and systems of the present disclosure may be implemented in many manners and as such are not to be limited by the foregoing exemplary embodiments and examples. In other words, functional elements being performed by a single or multiple components, in various combinations of hardware and software or firmware, and individual functions, can be distributed among software applications at either the client or server level or both. In this regard, any number of the features of the different embodiments described herein may be combined into single or multiple embodiments, and alternate embodiments having fewer than or more than all of the features herein described are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, and those variations and modifications that may be made to the hardware or software or firmware components described herein as would be understood by those skilled in the art now and hereafter.

While various embodiments have been described for purposes of this disclosure, various changes and modifications may be made which are well within the scope of the present invention. For example, in an embodiment the system may be provided via an application service provider remote from the client computing device. The client would be able to access the remote application via a browser. The application may have direct connections to the data sources and/or the client may provide the data in a data submission. The application could be hosted by the vending management company, a data collection service, or some other party.

Numerous other changes may be made which will readily suggest themselves to those skilled in the art and which are encompassed in the spirit of the invention disclosed and as defined in the appended claims.

What is claimed is:

1. A method for generating a validated vending machine commission statement for submission to a recipient comprising:
receiving a request from an operator to generate a validated commission statement for a period from vending sales data for the period;
generating, from the vending sales data, a machine list containing vending site data, the vending site data identifying at least one vending site and vending machines associated with each at least one vending site;
accessing a validation schedule for the period, the validation schedule containing vending site validation data derived from a previously submitted validated vending machine commission statement, the vending site validation data including a list of one or more expected vending sites and, for each expected vending site, an expected vending machine;
generating a draft commission statement containing the vending site data from the machine list and expected vending sites and expected vending machines that are not also included in the vending site data;
receiving site sales data for each vending machine and expected vending machine; and
generating the validated vending machine commission statement, the validated vending machine commission statement containing the vending site data from the machine list and expected vending sites and expected vending machines, site sales data for each vending machine and expected vending machine and a validation certificate.

2. The method of claim 1 further comprising:
retrieving a client identifier associated with the recipient;
accessing at least one data source containing the vending sales data;
identifying, based on the client identifier, vending site data associated with the recipient; and
retrieving the vending site data from the vending sales data associated with the recipient for the period from the at least one data source.

3. The method of claim 1 further comprising:
retrieving, from vending sales data, site sales data for each vending machine and each expected vending machine in the draft commission statement.

4. The method of claim 1 further comprising:
comparing the validation schedule to the machine list; and
identifying.

5. The method of claim 1 wherein accessing further comprises:
requesting the validation schedule from the recipient;
receiving the validation schedule from the recipient; and
maintaining the validation schedule in an encrypted form thereby denying the user direct access to the vending site validation data.

6. The method of claim 1 further comprising:
comparing the site sales data to site sales validation data; and
based on the comparison, including warnings in the validated commission statement identifying discrepancies between the site sales validation data and the site sales data.

7. The method of claim 6 further comprising:
including a warning if a commission rate in the validated commission statement does not match an expected commission rate in the site sales validation data.

8. The method of claim 6 further comprising:
calculating a total sales amount for each vending site in the validated commission statement;
comparing the total sales amount for each vending site to a previous vending site sales amount; and
including a warning identifying each vending site for which the total sales amount differs from the previous vending site sales amount by more than a predetermined amount.

9. A method for generating a vending machine commission statement comprising:
retrieving, from one or more sources, vending data for a period, the vending data related to machines located at different sites, wherein each machine is associated with at least one site;
verifying that each machine listed in a validation schedule is listed in the vending data;
verifying that each machine listed in the validation schedule is listed in the vending data at least once as associated with the same site as in the validation schedule; and
generating a validated vending machine commission statement containing the vending data.

10. The method of claim 9 wherein the vending machine commission statement is to be submitted to a recipient and the method further comprises:
requesting, from a server associated with the recipient, the validation schedule; and
receiving the validation schedule.

11. The method of claim 10 wherein the operations are performed by an application executing on a client computing device remote from server.

12. The method of claim 9 verifying that each machine listed in the validation schedule is listed in the vending data at least once as associated with the same site as in the validation schedule further comprises:
if a machine listed in the validation schedule as being associated with a site is not listed in the vending data at least once as associated with the same site,
alerting a user that an expected site was not listed in the vending data; and
preventing the generating operation until the vending data contains the expected site.

13. The method of claim 9 wherein verifying that each machine listed in a validation schedule is listed in the vending data further comprises:
if a machine listed in the validation schedule is not listing in the vending data,
alerting a user that an expected machine is not listed in the vending data; and
preventing the generating operation until the vending data contains the expected machine or an exception code.

14. The method of claim 9 further comprising:
retrieving sales data associated with the machines listed in the vending data;
generating a draft commission statement containing the vending data and sales data; and
verifying that sales data in the vending data meets one or more predetermined conditions.

15. The method of claim 11 wherein generating the validated vending machine commission statement further comprises:
generating an encrypted validated commission statement, the encrypted validated commission statement capable of being decrypted only by the application and the recipient.

16. The method of claim 9 wherein generating the validated vending machine commission statement further comprises:
generating an encrypted validation header indicating that the validated vending machine commission statement has been validated against the validation schedule; and
transmitting the encrypted validation header and the validated vending machine commission statement to the recipient.

17. A system for generating a validated commission statement from sales data comprising:
an application that when executed can retrieve sales data from at least one data source, the sales data including vending data for a period, the vending data related to machines located at different sites, wherein each machine is associated with at least one site;
the application further adapted to verify that each site listed in the vending data is listed in a validation schedule and to verify that at least one machine associated with each site in the vending data is listed in the validation schedule as associated with the same site;
the application further adapted to generate a validated commission statement containing the vending data; and
a client computing device adapted to execute the application.

18. The system of claim 17 wherein the application is further adapted to request a validation schedule from a remote computing device associated with the intended recipient of the validated commission statement.

19. The system of claim 18 further comprising:
a validation schedule generator on the remote computing device, the validation schedule generator adapted to generate and transmit a validation schedule in response to the application, the validation schedule containing validation data describing sites and machines that the recipient expects to find on the validated commission statement.

20. A computer-readable medium containing computer-executable instructions for performing a method for generating a vending machine commission statement, the method comprising:
retrieving, from one or more sources, vending data for a period, the vending data related to machines located at different sites, wherein each machine is associated with at least one site;
verifying that each site listed in the vending data is listed in a validation schedule;
verifying that at least one machine associated with each site in the vending data is listed in the validation schedule as associated with the same site; and
generating a validated vending machine commission statement containing the vending data.
